(19) United States
(12) Patent Application Publication
(10) Pub. No.: US 2024/0176129 A1
(43) Pub. Date: May 30, 2024

(54) OPTICAL FILTER FOR A MULTISPECTRAL SENSOR AND METHOD FOR MANUFACTURING SUCH A FILTER

(71) Applicants: COMMISSARIAT A L'ENERGIE ATOMIQUE ET AUX ENERGIES ALTERNATIVES, Paris (FR); STMicroelectronics (Crolles 2) SAS, Crolles (FR)

(72) Inventors: Sandrine VILLENAVE, Grenoble (FR); Quentin ABADIE, Grenoble (FR)

(73) Assignees: COMMISSARIAT A L'ENERGIE ATOMIQUE ET AUX ENERGIES ALTERNATIVES, Paris (FR); STMicroelectronics (Crolles 2) SAS, Crolles (FR)

(21) Appl. No.: 18/193,223

(22) Filed: Mar. 30, 2023

(30) Foreign Application Priority Data
Nov. 28, 2022 (FR) 2212409

(51) Int. Cl. G02B 26/00; G01J 3/26; G02B 5/28

(52) U.S. Cl. CPC G02B 26/001; G01J 3/26; G02B 5/28

(57) ABSTRACT

The present description concerns an optical filter intended to be arranged in front of an image sensor comprising a plurality of pixels, the filter comprising, for each pixel, at least one resonant cavity comprising a transparent region having a first refraction index and laterally delimited by a reflective peripheral vertical wall, and at least one resonant element formed in said region.

### CROSS-REFERENCE TO RELATED APPLICATION(S)

This application claims the priority benefit of French patent application number 2212409, filed on Nov. 28, 2022, entitled “Filtre optique pour capteur multispectral et procédé de fabrication d′un tel filtre” which is hereby incorporated by reference to the maximum extent allowable by law.

### BACKGROUND

### Technical Field

The present disclosure generally concerns multispectral sensors adapted to acquiring images of a scene in different wavelength ranges. The present disclosure more particularly aims at an optical filter for a multispectral filter, a multispectral filter comprising such a filter, and a method of manufacturing an optical filter for a multispectral sensor.

### Description of the Related Art

Multispectral sensors comprising a filter wheel placed in front of a sensor adapted to acquiring successive images of a scene through different filters of the wheel have been provided. Further, other multispectral sensors, more compact, comprising a single optical filter arranged in front of an image sensor, the filter being adapted to transmitting an incident radiation mainly in a first wavelength range towards certain pixels of the sensor and an incident radiation mainly in at least a second wavelength range, different from the first wavelength range, towards other pixels of the sensor, have been provided.

Existing multispectral sensors however have various disadvantages.

### BRIEF SUMMARY

An object of an embodiment is to overcome all or part of the disadvantages of known optical filters for multispectral sensors, of known multispectral sensors integrating such filters, and of known methods of manufacturing optical sensors for multispectral sensors.

For this purpose, an embodiment provides an optical filter intended to be arranged in front of an image sensor comprising a plurality of pixels, the filter comprising, for each pixel, at least one resonant cavity comprising a transparent region having a first refraction index and laterally delimited by a reflective vertical peripheral wall, and at least one resonant element formed in said region.

According to an embodiment, said at least one resonant element located in one of said at least one resonant cavity has a lateral dimension different from that of said at least one resonant element located in another resonant cavity.

According to an embodiment, one of said at least one resonant cavity has a width different from that of another resonant cavity.

According to an embodiment, each resonant element comprises a pad having a second refraction index greater than the first index.

According to an embodiment, each resonant element further comprises a transparent layer having a third refraction index greater than the first index and laterally extending in the resonant cavity.

According to an embodiment, the third index is substantially equal to the second index.

According to an embodiment, each resonant element comprises a portion of the transparent layer located inside of a through opening formed in a transparent layer having a fourth refraction index greater than the first index and laterally extending in the resonant cavity.

According to an embodiment, the filter comprises, for each pixel, a single resonant cavity.

According to an embodiment, the filter comprises, for each pixel, a plurality of resonant cavities.

According to an embodiment, the reflective peripheral vertical wall is made of a metal.

According to an embodiment, the reflective peripheral vertical wall comprises a stack of electrically-insulating layers made of materials having different refraction indexes.

According to an embodiment, the filter further comprises, for each cavity, a microlens located vertically in line with said cavity.

An embodiment provides a multispectral image sensor comprising an image sensor comprising a plurality of pixels formed inside and on top of a semiconductor substrate and an optical filter such as described.

An embodiment provides a method of manufacturing an optical filter intended to be arranged in front of an image sensor comprising a plurality of pixels, the method comprising the following successive steps:
a) forming, in a transparent layer, at least one resonant element for each pixel; and
b) dividing the transparent layer into a plurality of transparent regions, each comprising at least one of the resonant elements; and
c) covering the sides of each transparent region with a reflective peripheral vertical wall,
wherein the transparent region and the reflective peripheral wall form, for each pixel, a resonant cavity.

### BRIEF DESCRIPTION OF THE SEVERAL VIEWS OF THE DRAWINGS

The foregoing and other features and advantages of the present disclosure will be discussed in detail in the following non-limiting description of specific embodiments in connection with the accompanying drawing, in which:

FIG. 1 is a simplified and partial cross-section view of an example of a multispectral image sensor comprising an optical filter according to an embodiment;

FIG. 2 is a simplified and partial cross-section view of an example of a multispectral image sensor comprising an optical filter according to an embodiment;

FIG. 3 is a simplified and partial cross-section view of an example of a multispectral image sensor comprising an optical filter according to an embodiment;

FIG. 4 is a simplified and partial cross-section view of an example of a multispectral image sensor comprising an optical filter according to an embodiment;

FIG. 5A and FIG. 5B are simplified and partial views, respectively a top view and a cross-section view along plane AA of FIG. 5A, of an example of a multispectral image sensor comprising an optical filter according to an embodiment;

FIG. 6 is a simplified and partial cross-section view of an example of a multispectral image sensor comprising an optical filter according to an embodiment;

FIG. 7A, FIG. 7B, and FIG. 7C are cross-section views schematically and partially illustrating successive steps of an example of a method of manufacturing the optical filter of FIG. 1 according to an embodiment;

FIG. 8 is a cross-section view schematically and partially illustrating a step of a method of manufacturing a variant of the optical filter of FIG. 1;

FIG. 9A and FIG. 9B are cross-section views schematically and partially illustrating successive steps of an example of a method of manufacturing an optical filter according to an embodiment; and

FIG. 10A and FIG. 10B are cross-section views schematically and partially illustrating successive steps of an example of a method of manufacturing the optical filter of FIGS. 5A and 5B according to an embodiment.

### DETAILED DESCRIPTION

Like features have been designated by like references in the various figures. In particular, the structural and/or functional features that are common among the various embodiments may have the same references and may dispose identical structural, dimensional and material properties.

For the sake of clarity, only the steps and elements that are useful for an understanding of the embodiments described herein have been illustrated and described in detail. In particular, the forming of the photodiodes and of the pixel control circuits has not been detailed, the forming of such pixels being within the abilities of those skilled in the art based on the indications of the present disclosure.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, when reference is made to terms qualifying absolute positions, such as terms “front,” “back,” “top,” “bottom,” “left,” “right,” etc., or relative positions, such as terms “above,” “under,” “upper,” “lower,” etc., or to terms qualifying directions, such as terms “horizontal,” “vertical,” etc., it is referred, unless specified otherwise, to the orientation of the drawings.

Unless specified otherwise, the expressions “about,” “approximately,” “substantially,” and “in the order of” signify plus or minus 10%, preferably of plus or minus 5%.

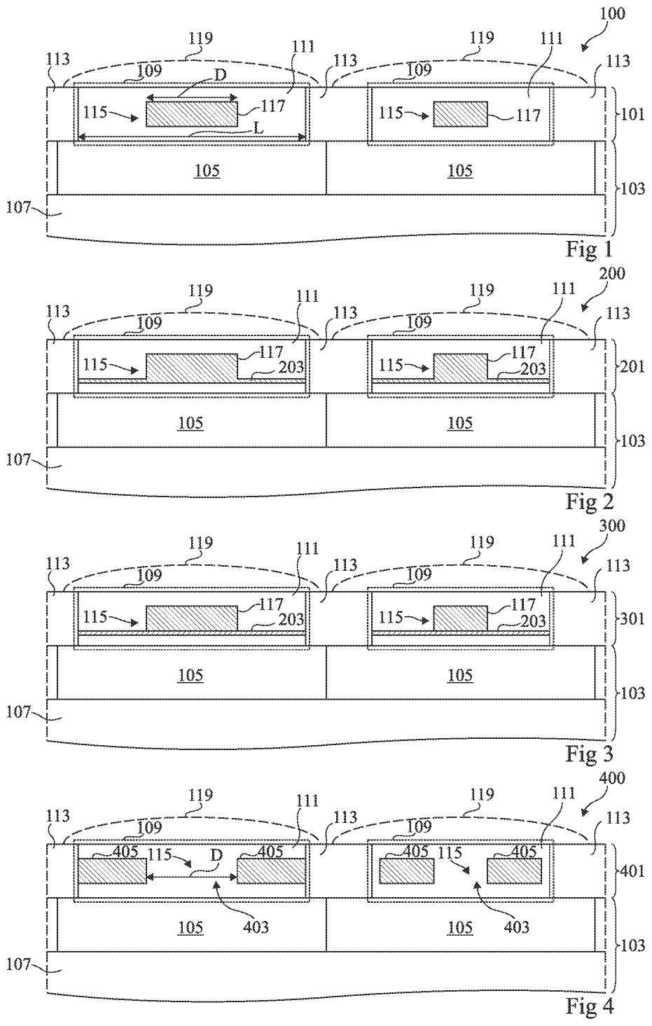

FIG. 1 is a simplified and partial cross-section view of an example of a multispectral image sensor 100 comprising an optical filter 101 according to an embodiment.

In the shown example, optical filter 101 is arranged in front of an image sensor 103, for example, a CMOS (“Complementary Metal-Oxide-Semiconductor”) sensor. Image sensor 103 comprises a plurality of pixels 105 formed inside and on top of a substrate 107. Substrate 107 is for example a wafer or a piece of wafer made of a semiconductor material, for example, silicon. Pixels 105 may have, in top view, any shape. As an example, each pixel 105 has, in top view, a periphery of polygonal shape, for example, rectangular or square, or of circular shape. Pixels 105 are for example arranged in an array along rows and columns. Although this has not been detailed in FIG. 1, control and readout circuits of pixels 105 may be formed inside and on top of substrate 107. Further, although only two pixels 105 have been illustrated in FIG. 1, image sensor 103 may of course comprise a much larger number of pixels 105, for example, several thousands or several millions of pixels 105.

According to an embodiment, the optical filter 101 intended to be arranged in front of image sensor 103 comprises, for each pixel 105 of image sensor 103, at least one resonant cavity 109 comprising a transparent region 111, laterally delimited by a reflective peripheral vertical wall 113, and at least one resonant element 115, formed in transparent region 111. Region 111 is made of a material transparent to the operating wavelengths of pixels 105 and having a refraction index n1. In the example illustrated in FIG. 1, optical filter 101 comprises, for each pixel 105, a single resonant cavity 109 comprising a single resonant element 115.

Resonant cavities 109 may have, in top view, any shape, for example identical to that of the underlying pixels 105. As an example, each resonant cavity 109 has, in top view, a periphery of polygonal shape, for example, rectangular or square, or of circular shape. Resonant cavities 109 for example have lateral dimensions smaller than or equal to those of pixels 105, the periphery of each resonant cavity 109 being, in top view, located respectively inside of or vertically in line with the periphery of the underlying pixel 105.

Reflective peripheral wall 113 for example has, in top view, a ring shape, for example, with a polygonal cross-section, for example, rectangular or square, or with a circular cross-section, surrounding or laterally bordering the transparent region 111 of each resonant cavity 109, the sides of transparent region 111 being covered with wall 113. As an example, reflective peripheral wall 113 has a height, or thickness in the order of 1 μm.

In the shown example, each resonant element 115 is a pad 117 of a material having a refraction index n2 greater than the refraction index n1 of the material of transparent region 111. Each pad 117 is for example coated, over all its surfaces, with the material of transparent region 111. Pads 117 may have, in top view, a cross-section having any shape. As an example, each pad 117 has, in top view, a periphery of polygonal shape, for example, rectangular or square, of circular shape, etc.

Pads 117 for example have a same height, or thickness, to within manufacturing dispersions. In the shown example, pads 117 are lateral and vertically centered with respect to resonant cavities 109. This example is however not limiting, and pads 117 may, as a variant, be off-centered with respect to resonant cavities 109. Pads 117 for example form a grating having a substantially constant pitch across the entire filter 101, the pitch of the grating corresponding to a center-to-center distance between two neighboring pads 117.

At least one of resonant cavities 109 may have, as in the example illustrated in FIG. 1, a width L different from that of another resonant cavity 109. The width L of a resonant cavity 109 corresponds to the maximum lateral dimension of this cavity. As an example, width L corresponds to the side length, respectively to the diameter, of resonant cavity 109, in the case where the cavity has, in top view, a periphery of square, respectively circular, shape.

Further, at least one of pads 117 may have, as in the example illustrated in FIG. 1, a lateral dimension D different from that of another pad 117. The lateral dimension D of a pad 117 for example corresponds to the side length, respectively to the diameter, of pad 117, in the case where the pad has, in top view, a periphery of square, respectively circular shape.

As an example, each resonant cavity 109 located in front of one of pixels 105 has a width L different from the widths L of the resonant cavities 109 located in front of the pixels 105 adjacent to the considered pixel. In other words, the resonant cavities 109 located in front of two adjacent pixels 105 have, in this example, different widths L. As a variant, adjacent resonant cavities 109 may have a same width L different from that of another resonant cavity 109.

Complementarily or alternatively, the pad 117 of each resonant cavity 109 located in front of one of pixels 105 for example has a lateral dimension D different from the lateral dimensions D of the pads 117 of the resonant cavities 109 located in front of the pixels 105 adjacent to the considered pixel. In other words, the pads 117 of the resonant cavities 109 located in front of two adjacent pixels 105 have, in this example, different lateral dimensions D. As a variant, the pads 117 of adjacent resonant cavities 109 may have a same lateral dimension D different from that of the pad 117 of another resonant cavity 109.

As an example, optical filter 101 may comprise a plurality of groups of resonant cavities 109, the resonant cavities 109 of a same group having a same cavity width L and comprising pads 117 having a same lateral dimension D, to within manufacturing dispersions. The width L of the resonant cavities 109 forming part of a same group is different from the widths L of the resonant cavities forming part of the other groups of cavities. Complementarily or alternatively, the lateral dimension D of the pads 117 of the resonant cavities 109 forming part of a same group is different from the lateral dimensions D of the pads 117 forming part of the other groups of cavities 109. Resonant cavities 109 forming part of a same group are for example arranged according to a regular pattern.

Each resonant cavity 109 of optical filter 101 is mainly resonant for a wavelength range of an incident radiation intended to be transmitted to a photosensitive area of the underlying pixel 105. The wavelength range transmitted by each resonant cavity 109 is, among others, a function of the width L of the considered resonant cavity 109 (the larger the width L of resonant cavity 109, the higher the wavelength of the radiation mainly transmitted to the underlying pixel 105). Thus, the fact of providing resonant cavities 109 having different widths L enables filter 101 to transmit the incident radiation in different wavelength ranges.

The wavelength range transmitted by each resonant cavity 109 is, further, a function of the lateral dimension D of pad 117 (the larger the lateral dimension D of pad 117, the higher the wavelength of the radiation mainly transmitted to the underlying pixel 105). Thus, the fact of providing resonant cavities 109 having pads 117 having different lateral dimensions D enables filter 101 to transmit the incident radiation in different wavelength ranges.

As an example, the modification of the width L of a resonant cavity 109 induces a shifting of the wavelength range of the radiation transmitted to the underlying pixel 105 greater than the shifting obtained by a similar modification of the lateral dimension D of the pad 117 of the cavity. In other words, modifying the lateral dimension D of the pad 117 of a resonant cavity 109 enables, in this example, to more finely adjust the wavelength range transmitted to the underlying pixel than what is allowed by the modification of the width L of the considered resonant cavity 109.

Thus, the fact of providing resonant cavities 109 having different widths L enables for example the optical filter 101 to cover a wider spectral band than that which could covered by means of a filter only comprising pads 117 having different lateral dimensions D. As an example, when image sensor 100 is adapted to capturing visible light and a near-infrared radiation, filter 101 may cover a spectral band extending over several hundreds of nanometers in a case where the limiting widths L of resonant cavities 109 are separated by several tens of nanometers. Further, the fact of providing pads 117 having different lateral dimensions D for example enables optical filter 101 to have a spectral resolution greater than that which would be achieved by means of a filter only comprising resonant cavities 109 having different widths L.

The multispectral sensor 100 integrating optical filter 101 advantageously has a compactness greater than that of multispectral sensors comprising a filter wheel and further has a wider spectral band and/or a higher spectral resolution than existing multispectral sensors comprising a single filter adapted to transmitting an incident radiation mainly in a first wavelength range to certain pixels of the sensor and an incident radiation mainly in at least a second wavelength range, different from the first wavelength range, to other pixels of the sensor.

An advantage of optical filter 101 lies in the fact that the presence of reflective peripheral wall 113 enables to favor the transmission of the radiation reaches optical filter 101 under an oblique incidence (that is, non-orthogonal to the upper surface of optical filter 101, in the orientation of FIG. 1).

Optionally, multispectral sensor 100 comprises microlenses 119. Each microlens 119 is for example located in front of a single resonant cavity 109 of optical filter 101. Microlenses 119 coat the surface of optical filter 101 opposite to pixels 105 (the upper surface of optical filter 101, in the orientation of FIG. 1). Microlenses 119 enable to favor the transmission of the incident radiation towards the pixels 105 of image sensor 103.

FIG. 2 is a simplified and partial cross-section view of an example of a multispectral image sensor 200 comprising an optical filter 201 according to an embodiment. The sensor 200 of FIG. 2 comprises elements common with the sensor 100 of FIG. 1. These common elements will not be detailed again hereafter.

The sensor 200 of FIG. 2 differs from the sensor 100 of FIG. 1 in that each resonant element 115 of the optical filter 201 of sensor 200 comprises, in addition to pad 117, a layer 203 laterally extending inside of the corresponding resonant cavity 109. Layer 203 for example extends, as illustrated in FIG. 2, along the entire length L of resonant cavity 109, layer 203 then being laterally delimited, or bordered, by reflective peripheral wall 113.

In the shown example, layer 203 is made of the same material of index n2 as pad 117. Layer 203 is transparent for the wavelength range of the incident radiation intended to be transmitted to the photosensitive area of the underlying pixel 105.

FIG. 3 is a simplified and partial cross-section view of an example of a multispectral image sensor 300 comprising an optical filter 301 according to an embodiment. The sensor 300 of FIG. 3 comprises elements common with the sensor 200 of FIG. 2. These common elements will not be detailed again hereafter.

The sensor 300 of FIG. 3 differs from the sensor 200 of FIG. 2 in that the transparent layer 203 of the optical filter 301 of sensor 300 is made of a material different from that of pad 117. The transparent layer 203 of the optical filter 301 of sensor 300 is for example made of a material having a refraction index n3 greater than the refraction index n1 of the material of transparent region 111 and different from the refraction index n2 of the material of pad 117.

Although FIGS. 2 and 3 illustrate examples where each pad 117 covers a portion of a surface of layer 203 (the upper surface of layer 203 in the orientation of FIGS. 2 and 3), each pad 117 may, as a variant, be separate from the underlying layer 203. In this case, each pad 117 is for example separated from layer 203 by a portion of transparent region 111.

FIG. 4 is a simplified and partial cross-section view of an example of a multispectral image sensor 400 comprising an optical filter 401 according to an embodiment. The sensor 400 of FIG. 4 comprises elements common with the sensor 100 of FIG. 1. These common elements will not be detailed again hereafter.

The sensor 400 of FIG. 4 differs from the sensor 100 of FIG. 1 in that each resonant element 115 of the optical filter 401 of sensor 400 comprises a portion of the transparent region 111 located inside of a through opening 403 formed in a layer 405 laterally extending inside of the corresponding resonant cavity 109. Openings 403 may have, in top view, a cross-section having any shape, for example, one of the shapes previously described for pads 117.

Layer 405 for example extends, as illustrated in FIG. 4, across the entire width L of resonant cavity 109, layer 405 then being laterally delimited, or bordered, with reflective peripheral wall 113. Layer 405 is transparent for the wavelength range of the incident radiation intended to be transmitted to the photosensitive area of the underlying pixel 105. As an example, layer 405 is made of the same material of index n2 as the pads 117 of filters 101, 201, and 301.

What has been previously described in relation with FIG. 1 in the case where resonant elements 115 are pads 117 of lateral dimension D can be transposed by those skilled in the art to the case where each resonant element 115 comprises a portion of transparent layer 111 located inside of an opening 403 of lateral dimension D formed in layer 405. In particular, a modification of the lateral dimension D of an opening 403 of optical filter 401 induces a shifting of the wavelength range of the radiation transmitted to the underlying pixel 105 (the larger the lateral dimension of an opening 403, the lower the wavelength of the radiation mainly transmitted to the underlying pixel 105).

The optical filter 401 of sensor 400 thus has advantages identical or similar to those of the optical filters 101, 201, and 301 of sensors 100, 200, and 300, respectively.

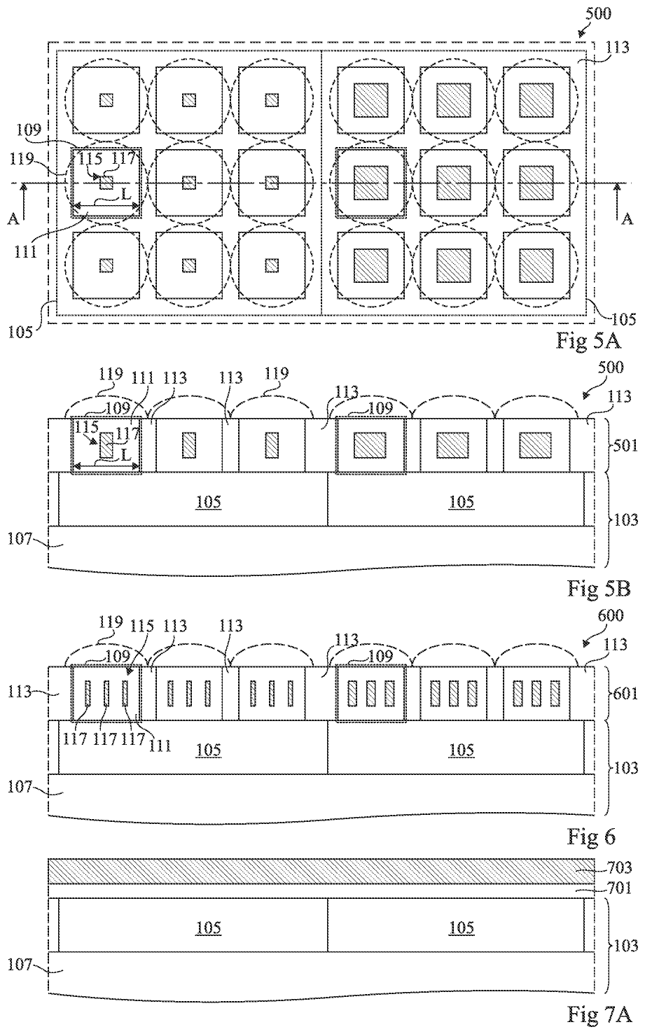

FIG. 5A and FIG. 5B are simplified and partial views, respectively a top view and a cross-section view along plane AA of FIG. 5A, of an example of a multispectral image sensor 500 comprising an optical filter 501 according to an embodiment. The sensor 500 of FIGS. 5A and 5B comprises elements common with the sensor 100 of FIG. 1. These common elements will not be detailed again hereafter.

The sensor 500 of FIGS. 5A and 5B differs from the sensor 100 of FIG. 1 in that the optical filter 501 of sensor 500 comprises, for each pixel 105 of image sensor 103, a plurality of resonant cavities 109 (nine resonant cavities 109, in the example illustrated in FIG. 5A). In the shown example, each resonant cavity 109 comprises a single resonant element 115. As an example, the pixels 105 of sensor 500 have lateral dimensions greater than those of the pixels 105 of sensor 100.

In the shown example, resonant elements 115 are pads 117 each having, in top view, a substantially square-shaped periphery. In the illustrated example, the pads 117 of resonant cavities 109 located in front of a same pixel 105 have substantially identical lateral dimensions D, to within manufacturing dispersions. The pads 117 of the resonant cavities 109 located in front of one of pixels 105 have for example lateral dimensions D (equal, in this example, to the side of the square formed, in top view, by each pad 117) different from those of the pads 117 of the resonant cavities 109 located in front of another pixel 105.

As an example, the resonant cavities 109 located in front of a same pixel 105 have identical widths L, to within manufacturing dispersions. To simplify the drawing, resonant cavities 109 have, in the example illustrated in FIGS. 5A and 5B, a same width L. This example is however not limiting, the resonant cavities 109 located in front of a pixel 105 being capable of having widths L different those of the resonant cavities 109 located in front of another pixel 105.

The fact of providing a plurality of resonant cavities 109 per pixel 105 advantageously enables optical filter 501 to favor the transmission of the incident radiation towards the pixels 105 of sensor 103, in particular when the radiation reaches optical filter 101 under an oblique incidence. This further advantageously enables optical filter 501 to have an angular acceptance, that is, an invariance of the spectral response of filter 501 according to the angle of incidence, greater than that of a nanostructured filter deprived of reflective walls 113.

FIG. 6 is a simplified and partial cross-section view of an example of a multispectral image sensor 600 comprising an optical filter 601 according to an embodiment. The sensor 600 of FIG. 6 comprises elements common with the sensor 500 of FIGS. 5A and 5B. These common elements will not be detailed again hereafter.

The sensor 600 of FIG. 6 differs from the sensor 500 of FIGS. 5A and 5B in that each resonant cavity 109 of the optical filter 601 of sensor 600 comprises a plurality of resonant elements 115. The resonant elements 115 of filter 601 are, in the shown example, pads 117 for example having, in top view, a substantially square shape. As an example, each resonant cavity 109 of optical filter 601 comprises nine pads 117.

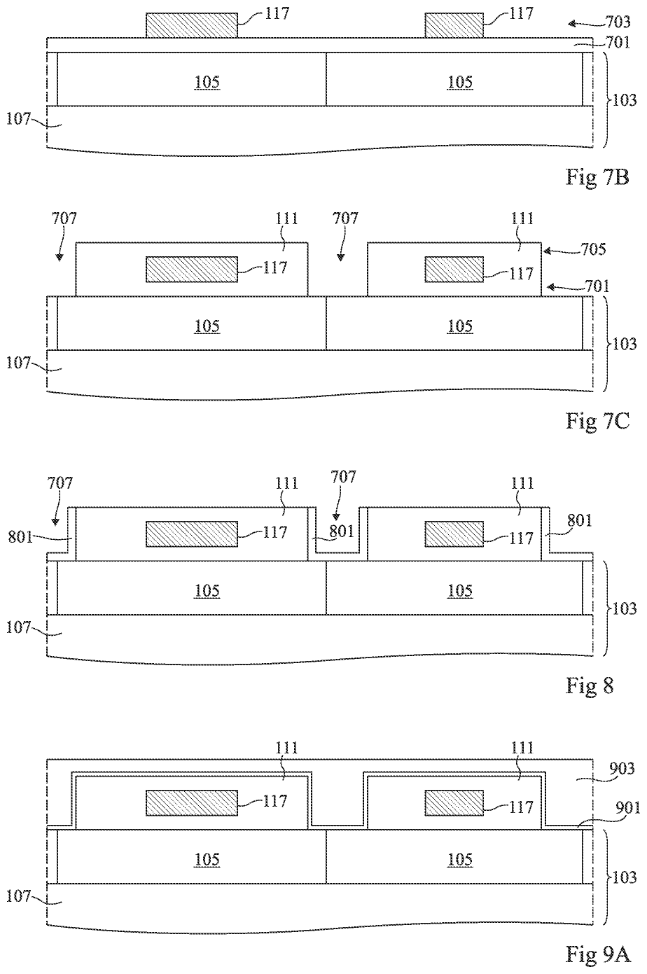

FIG. 7A, FIG. 7B, and FIG. 7C are cross-section views schematically and partially illustrating successive steps of an example of a method of manufacturing the optical filter 101 of FIG. 1 according to an embodiment.

FIG. 7A more precisely illustrates a structure obtained at the end of the forming of image sensor 103, particularly after the forming of pixels 105 inside and on top of substrate 107, and after the successive depositions of two layers 701 and 703. In the shown example, layer 703 covers a surface of layer 701 opposite to substrate 107 (the upper surface of layer 701, in the orientation of FIG. 7A).

As an example, layer 701 is made of silicon dioxide (SiO₂) and layer 703 is made of silicon (Si), of silicon nitride (SiN), or of titanium dioxide (TiO₂).

FIG. 7B more precisely illustrates a structure obtained at the end of a step of structuring, for example by photolithography and etching, of layer 703 to form pads 117.

In the shown example, the portions of layer 703 which laterally extend between pads 117 are totally removed during the etch step. As a variant, portions of layer 703 laterally extending between pads 117 and having a thickness smaller than that of pads 117 may be kept at the end of the etching, for example thus forming the layers 203 of the optical filter 201 previously described in relation with FIG. 2.

FIG. 7C more precisely illustrates a structure obtained at the end of a step of forming of the transparent layers 11 surrounding pads 117.

As an example, a transparent layer 705 made of the same material as that of layer 701 is first deposited on the upper surface side of the structure, transparent layer 705 for example covering pads 117 and portions of the upper surface of layer 701 non-covered with pads 117. Layers 701 and 705 are for example then structured, for example by photolithography and etching, to form transparent regions 111. In other words, transparent layers 701 and 705, which here form a same layer, are divided into a plurality of transparent regions 111, each comprising at least one of resonant elements 115.

In the shown example, transparent layers 111 are laterally separated by trenches 707.

Although this has not been detailed, subsequent steps comprising the deposition of a reflective layer made of a metal, for example, silver (Ag) or aluminum (Al), or of a metal alloy coating transparent regions 111 and filling trenches 707, followed by the planarization of the reflective layer, for example, by chemical mechanical polishing, are for example implemented from the structure illustrated in FIG. 7C to form reflective peripheral walls 113. In this case, walls 113 are made of the material of the reflective layer.

An optional step of forming of microlenses 119 may further be provided afterwards.

FIG. 8 is a cross-section view schematically and partially illustrating a step of a method of manufacturing a variant of the optical filter 101 of FIG. 1. The step illustrated in FIG. 8 for example follows steps identical or similar to those previously described in relation with FIGS. 7A to 7C.

In the shown example, the sides and the bottom of trenches 707 are coated with a reflective layer 801, for example, made of a metal or of a metal alloy. In the example illustrated in FIG. 8, reflective layer 801 does not fill trenches 707.

As an example, reflective layer 801 is first deposited on the upper surface side of the structure of FIG. 7C, for example by a conformal deposition technique. Portions of reflective layer 801 coating the surface of transparent regions 111 opposite to substrate 107 (the upper surface of regions, in the orientation of FIG. 8) are for example then removed, for example, by chemical mechanical polishing.

Although has not been detailed, subsequent steps comprising the deposition of a filling layer, for example, made of an electrically-insulating material, coating reflective layer 801 and filling trenches 707, followed by the planarization of the filling layer, for example, by chemical mechanical polishing, are for example implemented from the structure illustrated in FIG. 8 to form reflective peripheral walls 113. Reflective peripheral walls 113 comprise in this case portions of the filling layer flush with the upper surface of transparent regions 111, and having their bottom and their sides coated with reflective layer 801.

An optional step of forming of microlenses 119 may further be provided afterwards.

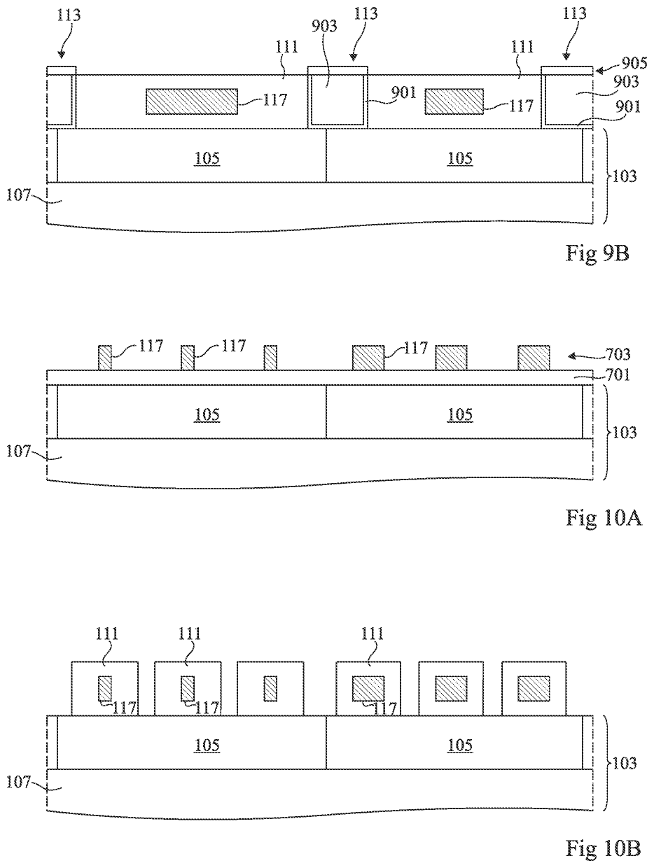

FIG. 9A and FIG. 9B are cross-section views schematically and partially illustrating successive steps of an example of a method of manufacturing an optical filter according to a embodiment.

FIG. 9A more precisely illustrates a structure obtained at the end of successive depositions of two layers 901 and 903 on the upper surface side of the structure illustrated in FIG. 7C. In the shown example, layer 901 coats the sides and the upper surface of transparent regions 111, and further coats portions of the upper surfaces of pixels 105 which are not coated with transparent layers 111. In the example illustrated in FIG. 9A, layer 903 coats layer 901 and fills trenches 707. As an example, layers 901 and 903 are obtained by conformal deposition.

Layer 901 is for example made of a material having a refraction index greater than that of the material of layer 903. As an example, the respective materials of layers 901 and 903 are selected from among the following pairs: silicon and silicon dioxide, silicon and silicon nitride, and titanium dioxide and silicon dioxide. As a variant, layer 901 is for example made of silicon nitride and layer 903 is omitted, an air vacuum being thus formed inside of trenches 707.

FIG. 9B more precisely illustrates a structure obtained at the end of a step of planarization of the stack formed by layers 901 and 903. As an example, steps of structuring by photolithography and etching, followed by a step of chemical mechanical polishing on the upper surface side of the structure illustrated in FIG. 9A, are implemented to planarize the stack formed by layers 901 and 903.

In the shown example, portions of layers 901 and 903 located vertically in line with transparent layers 111 are removed, and the portions of layers 901 and 903 remaining between transparent layers 111 are flush with the upper surface of transparent layers 111. In this example, reflective peripheral walls 113 comprising portions of layer 903 flush with the upper surface of transparent regions 111 and having their bottom and their sides coated with layer 901.

Reflective peripheral walls 113 for example form, in this case, Bragg mirrors. Although two layers 901 and 903 have been illustrated in FIGS. 9A and 9B, a stack comprising a greater number of two electrically-insulating layers having different refraction indexes may, as a variant, be provided.

FIG. 9B further illustrates a subsequent step of forming of masks 905 covering the portions of layers 901 and 903 located between transparent regions 111. As an example, a metal layer, for example made of tungsten, is first deposited on the upper surface side of the structure, the metal layer coating the upper surface of transparent regions 111 and the portions of layers 901 and 903 located between transparent regions 111. The metal region is for example then structured, for example, by photolithography and etching, to form masks 905. As a variant, masks 905 may be formed before the deposition of layers 901 and 903. In this case, masks 905 for example cover the bottom of trenches 707.

Masks 905 enable to avoid optical crosstalk phenomena between the pixels 105 of image sensor 103 as well as parasitic couplings and resonances.

An optional step of forming of microlenses 119 may further be provided afterwards.

FIG. 10A and FIG. 10B are cross-section views schematically and partially illustrating successive steps of an example of a method of manufacturing the optical filter 501 of FIGS. 5A and 5B according to an embodiment.

FIG. 10A more precisely illustrates a structure obtained at the end of a step of structuring, for example by photolithography and etching, of the layer 703 of the structure previously described in relation with FIG. 7A to form the pads 117 of optical filter 501.

In the shown example, the portions of layer 703 which laterally extend between pads 117 are totally removed during the etch step. As a variant, portions of layer 703 laterally extending between pads 117 and having a thickness smaller than that of pads 117 may be kept at the end of the etching.

FIG. 10B more precisely illustrates a structure obtained at the end of a step of forming of the transparent regions 111 surrounding pads 117.

As an example, a transparent layer made of the same material as that of layer 701 is first deposited on the upper surface side of the structure, the transparent layer for example coating pads 117 and portions of the upper surface of layer 701 non-covered with pads 117. The transparent layers are for example then structured, for example by photolithography and etching, to form transparent regions 111.

In the shown example, transparent layers 111 are laterally separated by trenches 707.

Subsequent steps of forming of reflective peripheral walls 113, for example similar to those previously described in relation with FIG. 7C, are for example implemented.

An optional step of forming of microlenses 119 may further be provided hereafter.

Various embodiments and variants have been described. Those skilled in the art will understand that certain features of these various embodiments and variants may be combined, and other variants will occur to those skilled in the art. In particular, the pads 117 of the optical filters 501 and 601 previously described in relation with FIGS. 5A, 5B, and 6 may be replaced with resonant elements 115 identical or similar to those of the optical filter 401 previously described in relation with FIG. 4, for example, resonant elements 115 comprising a portion of transparent region 111 located inside of a through opening formed in a transparent layer of refraction index greater than that of region 111.

Further, those skilled in the art are capable of adapting the method previously described in relation with FIGS. 7A and 7C to form the filter 301 of FIG. 3 by interposing, between layers 701 and 703, a layer for example having a thickness smaller than that of layer 703, this layer being for example used as an etch stop layer during the step described in relation with FIG. 7B. Those skilled in the art are further capable of adapting the method previously described in relation with FIGS. 7A and 7C to form the filter 401 of FIG. 4, particularly by etching layer 703, at the step described in relation with FIG. 7B, in order to form openings 403.

This skilled in the art are further capable of forming reflective peripheral walls 113 of filters 101, 201, 301, 401, 501, and 601 according to one of the variants described in relation with FIGS. 7C, 8, 9A, and 9B based on the indications of the present disclosure.

Finally, the practical implementation of the described embodiments and variants is within the abilities of those skilled in the art based on the functional indications given hereabove. In particular, those skilled in the art are particularly capable of adapting the width L of each resonant cavity 109 and the lateral dimensions D of resonant elements 115 according to the desired wavelength range, for example, by means of optical simulation computer tools.

Optical filter (101; 201; 301; 401; 501; 601) intended to be arranged in front of an image sensor (103) may be summarized as including a plurality of pixels (105), the filter including, for each pixel, at least one resonant cavity (109) including a transparent region (111) having a first refraction index and laterally delimited by a reflective peripheral vertical wall (113), and at least one resonant element (115) formed in said region.

Said at least one resonant element (115) located in one of said at least one resonant cavity (109) may have a lateral dimension (D) different from that of said at least one resonant element located in another resonant cavity.

One of said at least one resonant cavity (109) may have a width (L) different from that of another resonant cavity.

Each resonant element (115) may include a pad (117) having a second refraction index greater than the first index.

Each resonant element (115) may further include a transparent layer (203) having a third refraction index greater than the first index and laterally extending in the resonant cavity (109).

The third index may be substantially equal to the second index.

Each resonant element (115) may include a portion of the transparent region (111) located inside of a through opening (403) formed in a transparent layer (405) having a fourth refraction index greater than the first index and laterally extending in the resonant cavity (109).

Filter (101; 201; 301; 401) may include, for each pixel (105), a single resonant cavity (109).

Filter (501; 601) may include, for each pixel (105), a plurality of resonant cavities (109).

The reflective peripheral vertical wall (113) may be made of a metal.

The reflective peripheral vertical wall (113) may include a stack of electrically-insulating layers made of materials having different refraction indexes.

Filter may further include, for each cavity (109), a microlens (119) located vertically in line with said cavity.

Multispectral image sensor (100; 200; 300; 400; 500; 600) may be summarized as including an image sensor (103) including a plurality of pixels (105) formed inside and on top of a semiconductor substrate (107) and an optical filter (101; 201; 301; 401; 501; 601).

Method of manufacturing an optical filter (101; 201; 301; 401; 501; 601) intended to be arranged in front of an image sensor (103) may be summarized as including a plurality of pixels (105), the method including the following successive steps: a) forming, in a transparent layer (701, 705), at least one resonant element (115) for each pixel; and b) dividing the transparent layer into a plurality of transparent regions (111) each including at least one of the resonant elements; and c) covering the sides of each transparent region with a reflective peripheral vertical wall (113), wherein the transparent region and the reflective peripheral wall form, for each pixel, a resonant cavity (109).

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An optical filter, comprising,
at least one resonant cavity comprising a transparent region having a first refraction index and laterally delimited by a reflective peripheral vertical wall, and at least one resonant element formed in the region.

2. The filter according to claim 1, wherein said at least one resonant element located in one of said at least one resonant cavity has a lateral dimension different from that of said at least one resonant element located in another resonant cavity.

3. The filter according to claim 1, wherein one of said at least one resonant cavity has a width different from that of another resonant cavity.

4. The filter according to claim 1, wherein each resonant element comprises a pad having a second refraction index greater than the first index.

5. The filter according to claim 4, wherein each resonant element further comprises a transparent layer having a third refraction index greater than the first index and laterally extending in the resonant cavity.

6. The filter according to claim 5, wherein the third index is substantially equal to the second index.

7. The filter according to claim 1, wherein each resonant element comprises a portion of the transparent region located inside of a through opening formed in a transparent layer having a fourth refraction index greater than the first index and laterally extending in the resonant cavity.

8. The filter according to claim 1, wherein the reflective peripheral vertical wall is made of a metal.

9. The filter according to claim 1, wherein the reflective peripheral vertical wall comprises a stack of electrically-insulating layers made of materials having different refraction indexes.

10. The filter according to claim 1, further comprising, for each cavity, a microlens located vertically in line with said cavity.

11. A multispectral image sensor, comprising:
a semiconductor substrate;
an image sensor comprising a plurality of pixels formed inside and on top of the semiconductor substrate; and
an optical filter that includes:
at least one resonant cavity having a transparent region having a first refraction index and laterally delimited by a reflective peripheral vertical wall; and
at least one resonant element formed in the transparent region.

12. A method, comprising:
forming an optical filter in front of an image sensor that includes a plurality of pixels, the method comprising the following successive steps:
a) forming, in a transparent layer, at least one resonant element for each pixel; and
b) dividing the transparent layer into a plurality of transparent regions each comprising at least one of the resonant elements; and
c) covering the sides of each transparent region with a reflective peripheral vertical wall,
wherein the transparent region and the reflective peripheral wall form, for each pixel, a resonant cavity.

13. The method of claim 12, comprising forming the at least one resonant element located in one of said at least one resonant cavity to have a lateral dimension different from that of the at least one resonant element located in another resonant cavity.

14. The method of claim 12, comprising forming the at least one resonant cavity to have a width different from that of another resonant cavity.

15. A device, comprising:
a substrate;
a plurality of pixels in the substrate;
an optical filter on the plurality of pixels, the optical filter including:
a first resonant element;
a first transparent layer on the first resonant element;
a first reflective wall that is transverse to a surface of the substrate;
a second reflective wall that is transverse to the surface of the substrate, the first resonant element being between the first and second reflective walls.

16. The device of claim 15, wherein the optical filter includes
a second resonant element; and
a second transparent layer on the second resonant element.

17. The device of claim 16, wherein the optical filter includes a first resonant cavity that includes the first resonant element and a second resonant cavity that includes the second resonant element.

18. The device of claim 17, wherein the second reflective wall is between the first resonant cavity and the second resonant cavity.
